(19) United States
(12) Patent Application Publication
(10) Pub. No.: US 2023/0017952 A1
(43) Pub. Date: Jan. 19, 2023

(54) DRYING CYLINDER

(71) Applicant: Hewlett-Packard Development Company, L.P., Spring, TX (US)

(72) Inventors: Adria Olmos Marin, Sant Cugat del Valles (ES); Nestor Luid Pinol, Sant Cugat del Valles (ES); Albert Estella Aguerri, Sant Cugat del Valles (ES)

(21) Appl. No.: 17/374,058

(22) Filed: Jul. 13, 2021

(51) Int. Cl. B41F 23/04

(52) U.S. Cl. CPC B41F 23/0426; B41F 23/0486

(57) ABSTRACT

Examples relate to a drying cylinder for an image forming apparatus. The drying cylinder comprises a curved wall and a plurality of gas outlets spaced apart over the curved wall. The drying cylinder is to continuously rotate about its longitudinal axis and provide gas through the plurality of gas outlets perpendicularly onto a print medium with printing fluid deposited thereon to dry the printing fluid.

### BACKGROUND

Printing may be performed by applying printing fluid to a print medium and drying the printing fluid, for example by passing air over the printed area. It is desirable to be able to achieve a high print quality, including when printing on a large scale (e.g. where the printed area is at least a metre square). It is also desirable to achieve high print quality with a good throughput so the printing can take place on a reasonably quick timescale.

### BRIEF INTRODUCTION OF THE DRAWINGS

Example implementations are described below with reference to the accompanying drawings, in which:

FIG. 1 shows an example drying cylinder according to some examples;

FIG. 2 illustrates an example printing system according to some examples;

FIG. 3 depicts an example printing system with velocities of moving parts indicated according to some examples;

FIGS. 4a and 4b illustrate example graphs of velocity against time of parts of printing systems according to some examples;

FIG. 5 shows a method of printing according to some examples; and

FIG. 6 illustrates a computer readable medium according to some examples.

### DETAILED DESCRIPTION

Printing may be performed by applying printing fluid, such as inks, e.g. latex based inks, to a print medium, and drying the printing fluid. The print medium may also be called the substrate, or print media. The printing fluid may be dried in some examples by passing air over the printed area. For example, if latex ink is used, a hot air flow may be passed over the ink to cause it to cure. Throughout this description, where the term “drying” is used in relation to printing fluid, this may be taken to also mean “curing” in examples in which the printing fluid is dried through a curing process, such as a latex-based ink printing fluid. Drying may be understood to mean that water content or other solvent content is driven out (e.g. by evaporation) from the printing fluid to leave a remaining dry pigment. Curing may be understood to mean that some chemical reaction takes place in the printing fluid to cause it to be dry and fixed on the printing medium.

Some printers operate in a roll-to-roll way, whereby the blank print medium is fed from an input roll, through stages of printing fluid application and drying, and collected at the end of the process on an output roll. Roll-to-roll printers may be constructed as so-called scanning platforms, whereby a print medium is moved in steps, and a print carriage deploys printing fluid droplets at each step to build up the whole printed design. The printed regions are passed through a drying stage to dry the applied printing fluid. On a roll-to-roll printer which prints using latex based ink, for example, a large amount of energy may be used to cure the ink by driving off water and solvents of the ink, as well as creating a film that protects the printed design for improved durability of the printed medium.

An efficient way of providing energy to dry such inks is to provide hot air onto the deposited printing fluid by forced convection. For example, high pressure air may be heated inside a chamber and blown onto the printed medium through a series of small holes located in an element called an impinging plate. An impinging plate is an element, which may be a flat plate, in which air holes are located and through which air may be provided onto a print medium to dry printing fluid on the medium. It can be difficult to achieve a good level of uniformity of drying of the printing fluid, because there is a balance to be had between providing the hot air through small enough holes that sufficient heat energy is focused onto the printed medium to cause the printing fluid to dry correctly, and that there are enough holes that a uniform coverage of hot air may be supplied across the printed medium.

A factor influencing the final quality of printed design is the distance of the printed surface of the print medium from the impinging plate surface at which the air holes are located. To reduce print defects caused by the print medium moving through the drying area (i.e. past the air holes in the impinging plate), the distance between the substrate surface and the impinging plate may be above a threshold minimum separation. This is because, if the distance is too small (e.g. below a threshold minimum separation) then the air flow may be sufficiently non-uniform across the print medium that some areas are dried while others are not sufficiently dried. However, the smaller the distance between the substrate surface and the impinging plate is, generally, the better the drying capacity is of the drying system because less energy is wasted in heating surrounding air if the impinging plate holes are close to the substrate surface. Certain printing fluids, such as latex based inks, are dried by using a relatively high amount of heat energy applied to the inks to cure the inks properly.

One way to try and reduce print quality defects is to increase the distance between the print medium and the drying elements (e.g. curing modules, impinging plate), on the assumption that the separation of the print medium and the impinging plate is so small is contributes to the cause of the print defects. Such a printing system would have separation adjustment capabilities to make the adjustment in separation distance between the medium and impingement plate. Such an approach would also have a high impact on curing capability, because the increased separation distance would provide a less efficient curing power of the gas flow onto the print medium. Thus, a decrease in performance (i.e. a decrease in energy efficiency) arises when the separation distance is increased.

One way to improve the provision of uniform hot air to dry the printing fluid is to perform drying over plural successive step-wise advances of the printed medium. An aim in this approach is to dry different portions of the printed design at different positions of the print medium relative to the air-supplying holes. In examples where different print modes may be used, and/or where different lengths of print medium may be used, which may each involve a different number of passes of the printed medium through the drying stage, it may be that the uniformity of air supplied to dry the printing fluid is not sufficient to ensure that the printing fluid is dried in the same way over the whole printed design. Impinging plates may be made with a hole pattern which is designed to have a specific hole arrangement to provide a good uniformity of gas outflow. The print medium may be moved to pass by the hole pattern by a predetermined number of times, aiming to provide a good balance between good drying and not taking too many passes. For example, six times (i.e. six passes of the medium past the air holes) may be made. Such a process may be used in different printing systems as a common “standard” for printing, using six passes with an assumed 100% of ink density. However, this method is an approximation, and print quality defects may still occur, while also requiring several passes of the medium through the drying zone of the printing system.

Another approach to try and improve print quality is to decrease the ink density used to try and mitigate against print quality defects arising through improperly dried printing fluid. However, while a lower density of ink may lead to a lower impact of print quality caused by defects arising from improperly dried printing fluid, overall the ink density is lower and so the overall print quality (e.g. in terms of intensity and colour saturation) may be lower than desired.

A lack of uniformity of drying can have a high impact on image quality, which in some cases may lead to holes or voids being present in a final printed design where the deposited printing fluid has not been dried sufficiently. To counteract such effects, the throughput of the printer may be decreased—in other words, the print medium passes through the printing system more slowly—to try and ensure all the printing fluid is dried, but this undesirably takes more time to produce each printed design.

It is desirable to be able to achieve a high print quality, including when printing on a large scale (e.g. where the printed area is at least a metre square). It is also desirable to achieve high print quality with a good throughput so the printing can take place on a reasonably quick timescale.

Examples disclosed herein may provide a solution which allows for improved continuity and uniformity of movement between a printed medium and the impinging system acting to dry the printing fluid, which also enables improvements in the printer system capacity (specifically the drying system capacity, i.e., throughput) and helps to overcome common print quality defects (sometimes called IQ defects) caused by, for example, repeated stops and starts of the step-wise movement print medium through the drying system, and/or an insufficiently uniform gas flow to dry the printing fluid.

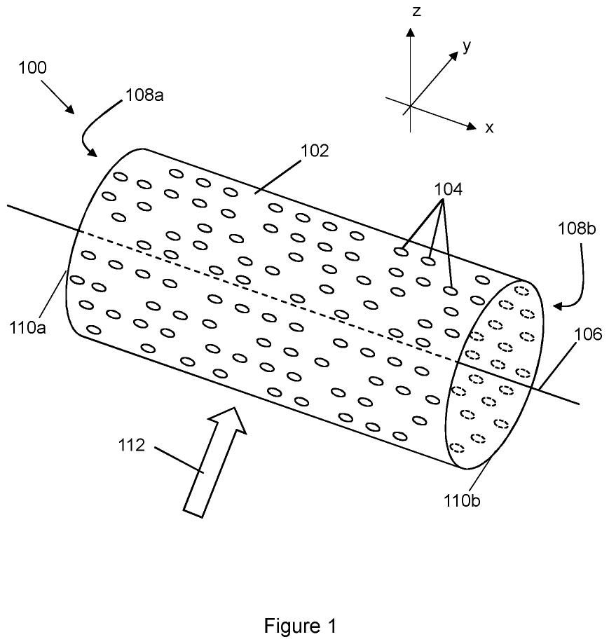

FIG. 1 shows an example drying cylinder 100. The drying cylinder is for an image forming apparatus, such as a roll-to-roll printer. The drying cylinder 100 comprises a curved wall 102, which may be considered to be a form of impinging plate. The drying cylinder 100 also comprises a plurality of gas outlets 104 spaced apart over the curved wall 102. The gas outlets 104 may be arranged in a pattern which allows for a good uniformity of gas distribution from the curved wall. The illustrated spatial distribution of gas outlets 104 is schematic.

The cylinder 100 has a longitudinal axis 106 (shown here in the x direction) passing through the centres of the two opposite ends 108a, 108b (shown here in the y-z plane). In some examples the ends 108a 108b may comprise walls, thereby forming a cylindrical shell with the curved wall 102. The longitudinal axis 106 of the drying cylinder 100 may be oriented perpendicularly to a print direction of the print medium. As shown in FIG. 1, a print medium may be advanced in a print feed direction 112 through a printing system in they direction as illustrated, and the longitudinal axis 106 is oriented in the x direction. In this way, there may be a minimum separation between the curved surface 102 and the print medium which is uniform along a line of the curved surface 102 parallel to the longitudinal axis 106. In examples where the print medium is curved (e.g. concentrically with the curvature of the curved surface 102), there may be a minimum separation between the curved surface 102 and the print medium which is uniform over an area of the curved surface 102 curved concentrically with the curved surface 102 of the cylinder 100. This separation is the distance between the printing fluid on the print medium surface which is to be dried, and the gas outlets 104.

The drying cylinder 100 may have a distance between the two opposite edges 110a, 110b of the cylinder which is at least the width of a printable area of the print medium. In some larger-scale printing systems, the width of the printable area may be, for example, up to 1.5 m, up to 2 m, or up to 3.2 m wide. By using a drying cylinder 100 with a width at least that of the printable area, the printable area may be treated by gas provided from the cylinder 100 as the print medium passes the cylinder surface 102 without plural back-and-forth passes of the print medium past the cylinder 100.

The drying cylinder 100 is to continuously rotate about its longitudinal axis 106 and provide gas through the plurality of gas outlets 104 perpendicularly onto a print medium with printing fluid deposited thereon to dry the printing fluid. Gas flow from the outlets 104 may be achieved (for example, by achieving a suitable cylinder surface—print medium separation distance, and/or a suitable gas pressure at the gas outlets) so that the emitted gas forms a cone-shape with a focus (i.e. the top of the gas cone) at the print medium surface to provide sufficient gas flow to dry the deposited printing fluid at that location. By providing the gas perpendicularly, a suitable gas flow profile onto the print medium surface may be achieved to cause the printing fluid to dry effectively. The drying cylinder 100 therefore provides an effect comparable to an impinging plate by providing drying gas flow onto the print medium, and thus may be called a rotating, or rotatory, impinging plate or impinging cylinder.

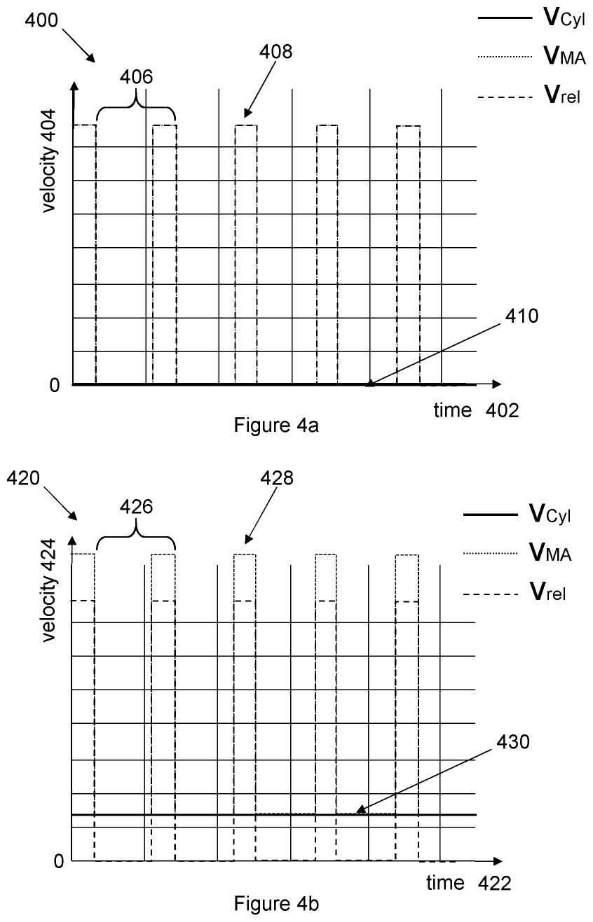

The drying cylinder 100 is to continuously rotate relative to a print medium with printing fluid deposited thereon moved stepwise past the cylinder, to provide a continuously non-zero relative velocity between the curved wall and the print medium. This is discussed more in relation to FIGS. 4a and 4b. By rotating the drying cylinder, there remains a non-zero relative velocity between the gas emitted from the gas outlets 104, and the surface of the print medium, even if the print medium is not being moved itself (for example, because a portion of the print medium is being printed on while another already-printed portion is being dried). For example, some print systems may print by a) applying some printing fluid from a print head to a portion of the print medium with no relative movement between the print head and the print medium; b) advancing (moving) the print medium to align a non-printed portion of the print medium with the print head for subsequent printer fluid deposition; and c) applying further printing fluid from the print head to the non-printed portion of the print medium with no relative movement between the print head and the print medium. In this way a printed image may be build up in a step-wise manner. However, during the times when printing is taking place, the print medium is stationary. By continuously rotating the drying cylinder 100, a non-zero relative velocity is maintained between the print medium and the position of impingement of the drying gas on the print medium, even when the print medium is not moving. By causing the continual non-zero relative velocity between the impinging gas flow onto the print medium and the print medium, an improved print quality may be achieved because improved uniformity of gas flow to dry applied printing fluid is achieved.

The plurality of gas outlets 104 may comprise a plurality of apertures through the curved wall 102 in some examples. In such examples, a gas flow system to provide gas for emission through the outlets 104 may be considered to be a centralised system, for example whereby gas is introduced inside the cylinder 100 under pressure and expelled through the gas outlets 104. For example, a pump may be used to pump gas into the interior of the cylinder 100. In some examples the gas to be provided through the gas outlets may be heated compared to the ambient temperature (e.g. room temperature). Heated gas may be used to help to dry certain printing fluids. Thus in some examples, the drying cylinder 100 may comprise a heater to heat gas; and a pump to blow the heated gas through the plurality of apertures 104 onto the print medium.

In other examples, rather than a centralised gas supply and an array of passive holes as gas outlets 104, each gas outlet may be a self-contained gas provision element, which may be termed a diffuser. Thus, the plurality of gas outlets 104 may comprise a plurality of diffusers located on the curved wall 102, and the plurality of diffusers are to pump gas onto the print medium. The diffusers may be placed around the cylinder curved surface 102 in a 360° configuration or similar (i.e. distributed over the curved surface 102 for uniform air flow as the cylinder rotates).

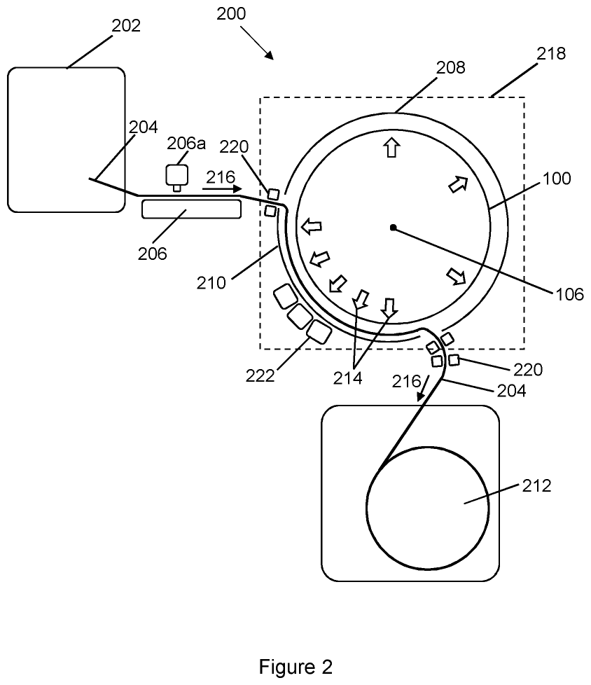

FIG. 2 illustrates a schematic view of an example roll-to-roll printing system 200. The printing system 200 comprises a drying cylinder 100 as described in relation to FIG. 1. The printing system 200 may operate similarly to a roll-to-roll printer using a static impinging plate for drying deposited printing fluid, but the impinging plate is replaced by the drying cylinder 100 providing gas, e.g. hot air, to dry the printing fluid. The schematic view is as if the cylinder 100 is being viewed end-on, with the longitudinal axis 106 perpendicular to the page. Also shown is a print medium input roll unit 202, a print medium 204, a print zone/printing region 206, a gas diverter 208, a print medium support 210, and a print medium output roll unit 212. The print medium 204 is advanced through the system 100 in a print feed direction 216 from the input roll unit 202, through the print zone 206 at which printing fluid is deposited onto the medium, past the surface of the drying cylinder 100, and is rolled back up at the output roll unit 212. There is a printing unit 206a in the printing region 206. The printing unit 206a, which may be termed a printhead 206a in some examples, is to deposit printing fluid, such as a latex-based printing fluid/ink, onto the print medium 204.

Advancing the print medium 204 is performed by a feed unit to move a print medium 204 in a print direction 216, which in this example, is from the input roll to the output roll. The feed unit in this example may be considered to be the input and output roll units 202, 212 acting to rotate and move the print medium 204 through the printing system 200. In a roll-to-roll printing system 200, the print medium may be attached to the input roll (releasing media) at the input roll unit 202, and attached to the output roll (collecting media) at the output roll unit 212. The print medium 204 will thus have a minimum tension along all the printer medium path from the input roll unit 202 to the output roll unit 212. In other print systems other feed mechanisms may be employed to progress the print medium 204 through the printer.

The drying cylinder 100, as in FIG. 1, comprises a plurality of gas outlets at the curved wall of the drying cylinder 100, and the longitudinal axis 106 of the drying cylinder 100 is oriented perpendicularly to the print direction 216. The feed unit 202, 212 is to move the print medium 204 from the printing region 206, through a drying region 218 in which the drying cylinder 100 is located. The drying cylinder 100 is to provide gas 214 through the plurality of gas outlets perpendicularly onto the print medium 204 with printing fluid deposited thereon to dry the printing fluid. A gas diverter 208 may be present, which acts as a shield to mitigate against gas flow escaping from the printing system 200 in a direction away from the print medium 204. In particular, in cases where the gas flow is heated gas flow, it is desirable to provide an energy efficient system which aims to minimise energy losses through hot gas escaping. Thus, the gas diverter 208 acts to retain heated gas close to the drying cylinder 100 to mitigate against energy losses by trapping the hot gas in the print system. The trapped hot gas is kept close to the drying cylinder 100 to help maintain an elevated gas temperature in proximity to the crying cylinder 100. The gas diverter 208 also acts as a shield to prevent gas blowing out form the printing system which may be impractical or irritating in a real working printing environment with other machinery or users operating in the vicinity. The drying cylinder 100 may be at least as wide as the total width of the printable area of the print medium to allow the whole printable area to be dried as the print medium advances through the system without re-passing the medium through the drying region 218 plural times to dry different portions of the print medium.

The cylinder 100 may rotate continuously as the printing system is in use to provide a non-zero relative velocity between the print medium 204 and the gas flow 214. The cylinder rotation may be at a constant velocity in some examples. The air flow 214 from the gas outlets is perpendicular to the surface of the print medium 204 which aids in focusing the gas flow onto the medium surface to facilitate drying. In examples where the printing fluid is to be cured, for example if the printing fluid is a latex based ink, achieving a focused hot air flow onto the printing media helps to provide sufficient heat energy on the medium to cure the ink correctly. By continuously rotating, the curved surface of the cylinder 100 always has a non-zero relative velocity in relation to the print medium 204. This relative motion both improves throughput of print medium through the system 200, and improves the overall print quality as printing defects such as impinging marks, caused by a stop-start motion of the medium with respect to the drying gas flow, are reduced or eliminated. The appearance of low print quality marks (which may be called impinging marks when arising due to imperfect drying by an impinging plate) may be much reduced. The impinging marks may appear as dots or regions of different colour and/or different gloss in the printed design.

To maintain the print medium 204 on a curved path concentric with the curvature of the curved wall of a segment of the drying cylinder 100, the printing system 200 may comprise one or more print medium diverters 220, 222 to guide the print medium 204 along the desired feed path in some examples. In some examples, the print medium diverters may be one or more print medium edge holders 220 to guide an edge of the print medium 204 along a curved path concentric with the curvature of the curved wall of a segment of the drying cylinder 100. The edge holder(s) 220 may be located out of the limits of the printable area of the print medium 204, to help avoid the edge holder(s) 220 from contacting the wet printing fluid. The diverter(s) 220 may also act to maintain a minimum distance/separation between the print medium 204 and the curved surface of the drying cylinder 100, helping to avoid the drying cylinder 100 surface from touching wet printing fluid on the print medium 204. The edge holder(s) 220 may also help to maintain a desired separation between the curved surface of the cylinder 100 and the print medium 204 for good printing fluid drying action of the gas outflow 214.

The print medium 204 may be guided along a concentric path around a portion of the curved surface of the drying cylinder 100 in some examples by using a circular bottom plate 210 to which the print medium 204 is held. In such examples a vacuum unit 222 may be present as a diverter, to maintain the print medium 204 on a curved path through the printing system 200 past the drying cylinder 100. The vacuum unit 222 is to pull the print medium 204 onto a curved support plate 210 which follows a curved path concentric with the curvature of the curved wall of a segment of the drying cylinder 100. This may help to maintain the desired curved print medium feed path. In some examples, both a vacuum unit 222 with bottom plate 210, and one or more edge holders 220 may be employed to maintain the print medium 204 on the desired print feed path. A “segment” of the drying cylinder 100 may be considered to be a horizontal cylindrical segment, or a cylindrical wedge; in either case the segment defines a portion of the total cylindrical curved surface past which the print medium 204 is fed at a desired separation distance to cause gas flow from the curved surface of the cylinder 100 to dry wet printing fluid on the medium 204.

The feed unit 202, 212 may be to move the print medium 204 stepwise in a print direction 216 to move the print medium 204 through the printing system 200. The stepwise motion may be made so that, while the print medium 204 is stationary in the printing system 200, a portion of the overall printed design may be formed by depositing printing fluid in the print region 206 as a strip of the overall printed design. For example, the printing fluid may be deposited by a print head 206 which raster scans across the width of the print medium to deposit printing fluid. Following printing of the strip, the print medium 204 may then be advanced through the printing system 200 so that the printing fluid of the printed strip may be dried in the drying region 218 while a subsequent portion of the printed design is printed on a next portion of the print medium 204. There may be plural wet-fluid printed regions between the print zone 206 and the drying region 218 in some examples.

During the step-wise movement of the print medium 204 through the printing system to allow for deposition of printing fluid, the drying cylinder 100 is to continuously rotate. As such a non-zero relative velocity between the print medium 204 surface and the perpendicular gas flow from the drying cylinder 100 is achieved. The continuous relative movement of the print medium with respect to the gas outlets enables new, or different, designs of impinging plates—in particular, the specific spatial arrangement of gas outlets in the impinging plate surface—because the non-zero relative movement breaks the relation between the pattern of the gas outlets and the separation distance of the print medium from the gas outlets/impinging plate surface. By reducing the risk/prevalence of print quality errors caused by impinging marks compared with print systems in which the impinging plate is stationary with respect to the print medium by causing the nonzero relative movement, it is possible to decrease the separation between the impinging plate and the print medium and retain an acceptable print quality. Decreasing the separation increases the drying capabilities for a given system/settings. In some examples, the drying efficiency increases exponentially as the separation distance decreases, while still mitigating against the formation of impinging marks affecting the print quality. By achieving higher drying capacities, due to the possibility of smaller impinging distances/separations for a given design, higher throughput is possible, thereby decreasing the overall time taken to print a design.

Smaller impinging distances also reduce the system power requirements for a given print job/production. Decreasing the separation increases energy efficiency in relation to providing (heated) gas for drying. That is, by decreasing the impinging distance while maintaining an acceptable print quality, improvements in power consumption may be made. Rather than power consumption, an end user looking to select a printing system may be interested to know the printer system throughput (the m²/h of printing medium which may be printed), because this parameter impacts productivity. However, this parameter is directly related to power consumption. By providing a printing system with a decreased impingement separation, and therefore improved energy consumption, an end user can reach the same throughput as with other printing systems which do not employ a drying cylinder (e.g. which have a static impinging plate), with the same or better image quality, and achieve lower electrical power consumption. Thus the cost per m² of a printed job may be cheaper using a printing system as disclosed herein. As another end user consideration, some end user facilities may need to adjust or update their electrical installations to provide a sufficiently powerful power supply to use a high energy consumption printer. Increasing the energy efficiency through using examples discussed herein may reduce the need for additional adjustments to power provision at end user facilities in order to run the printing system. This may improve (decrease) the metric of energy required to print per unit area (kW/m²).

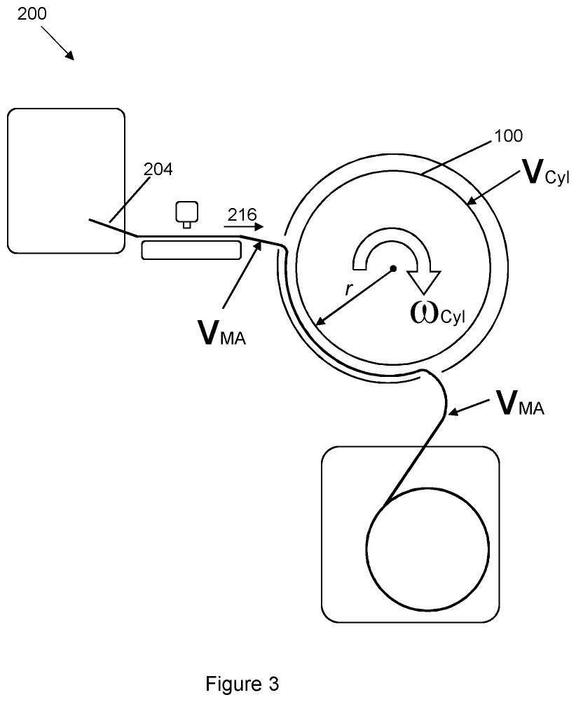

FIG. 3 depicts an example printing system indicating velocities of moving parts. Parts in common with the system 200 of FIG. 2 are not discussed again in detail. Illustrated is the print direction 216 of the print medium 204, and the drying cylinder 100. The print medium 204 moves/advances at a velocity V_{MA} through the printing system 200. This velocity may be variable, and periodically zero, for a stepwise movement of the print medium 204. The drying cylinder 100 has an angular velocity of ω_{Cyl} which is non-zero, and may be constant. This angular velocity ω_{Cyl} may also be expressed as a velocity of the surface of the drying cylinder (i.e. of the gas outlets on the cylinder surface) of V_{Cyl}=ω_{Cyl}r, where r is the cylinder radius. Thus, the velocity of the print medium relative to the velocity of the drying cylinder surface is Vᵣₑₗ=V_{Cyl}+V_{MA} when, as shown, the print medium is advanced in a direction opposite to the direction of movement of the cylinder surface (clockwise as shown in FIG. 3).

FIGS. 4a and 4b illustrate example graphs 400, 420 of velocity 404, 424 against time 402, 422 of parts of a printing system according to some examples. In FIG. 4a, the graph 400 relates to a printing system comprising a stationary impinging plate. In FIG. 4b, the graph 420 relates to a printing system comprising a rotating impinging plate (e.g. a drying cylinder 100). FIGS. 4a-b illustrate the stepwise movement of the print medium has a velocity V_{MA} which is illustrated in an idealised way as a square wave having a periodic velocity of zero velocity when the medium is not moving (e.g. it is being printed on) and a non-zero constant velocity 408 as the medium is fed through the print system. One period 406, 426 of stepwise movement is indicated on each graph 400, 420. Because the impinging plate in the example of FIG. 4a is a static plate, it has zero velocity V_{Cyl}. Therefore, the relative velocity Vᵣₑₗ of the medium with respect to the impinging plate surface is the same as that of the velocity of the medium, and therefore has zero velocity 410 and non-zero velocity 408 portions. During the zero velocity 410 time periods, the print medium is exposed to a stating impinging plate which can cause impinging marks as print defects as discussed above.

In the example of FIG. 4b, a continuously rotating drying cylinder is used. Thus, the impinging surface (the surface of the cylinder) has a non-zero velocity V_{Cyl}. In the graph 420 this is shown as a constant velocity, but in other examples it may vary and remain non-zero. The print medium advances in the same way as in FIG. 4a, in a stepwise manner. Here, the relative velocity Vᵣₑₗ of the medium with respect to the impinging plate surface is a non-zero velocity 428, 430 due to the rotation of the drying cylinder moving the impinging surface as the print medium advances. This non-zero relative motion causes a reduction in the presence of impinging marks as print defects.

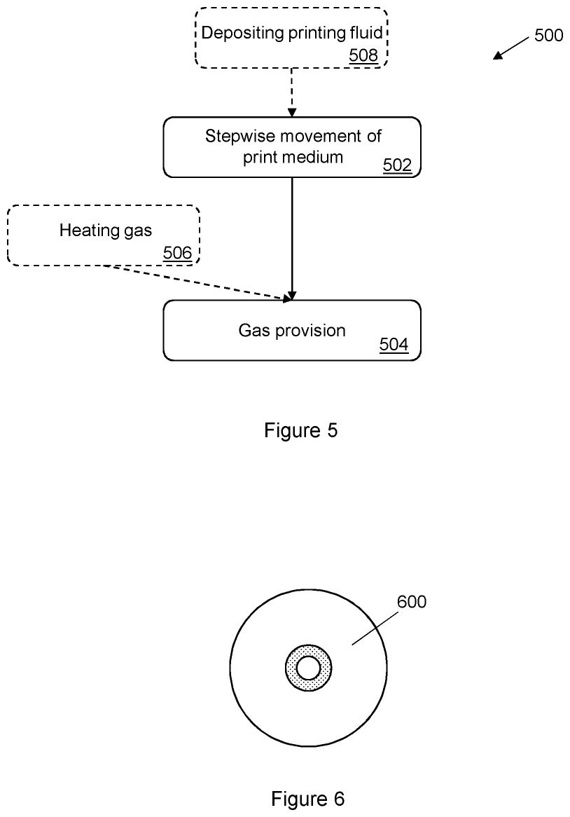

FIG. 5 shows a method of printing 500. The method 500 comprises moving a print medium 502 stepwise in a print direction to a drying area. The print medium has printing fluid, such as with latex-based printing fluid, deposited thereon. The method 500 in some examples may comprise depositing the printing fluid 508. The method 500 comprises, while moving the print medium stepwise, providing gas perpendicularly onto the print medium in the drying area 504. The gas is provided through a plurality of gas outlets in the surface of a continuously rotating drying cylinder, and acts to dry the printing fluid (e.g. for a latex-based printing fluid, the gas may act to cure the printing fluid). Thus in some examples, the method 500 may comprise heating gas 506 to be supplied through the plurality of gas outlets, and in such examples, providing the gas 504 comprises providing the heated gas perpendicularly onto the print medium to cure the (e.g. latex-based) printing fluid.

FIG. 6 illustrates a (e.g. non-transitory) computer readable storage medium 600 having executable instructions stored thereon. The computer executable instructions stored thereon, when executed by a processor, cause the processor to perform any method of controlling a printing system as disclosed herein. The machine readable storage 600 can be realised using any type or volatile or non-volatile (non-transitory) storage such as, for example, memory, a ROM, RAM, EEPROM, optical storage and the like. For example, the storage medium 600 may have stored thereon computer executable instructions to control a printing system to control the operation of a drying cylinder to provide gas onto the surface of the print medium while causing the drying cylinder to rotate so the emitted gas causes printing fluid on the print medium to dry. The computer executable instructions in some examples may also control the stepwise movement of a print medium through the printing system.

Examples disclosed herein may allow for a reduction in print defects (e.g. IQ defects due to use of a static impinging plate) by providing a continuously moving series of gas outlets to pass over a print medium having printing fluid deposited thereon, so that emitted gas from the gas outlets dries the printing fluid while the gas outlet is continuously moving relative to the print medium. By providing a moving gas emitter, the separation between the gas outlets and the print medium may be reduced while still obtaining an acceptable print quality compared to printing using a stating impinging plate (i.e. static gas outlets). In this way, printing as disclosed herein may allow for an increased throughput, because the energy in the system used to provide (and in some examples, heat) gas for emission onto the print medium is more efficiently used to dry deposited printing fluid. In latex-based ink printing this may be particularly useful because the latex-based inks are to be heated to a sufficiently high temperature to cause them to cure correctly.

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the context suggests otherwise. In particular, where the indefinite article is used, the specification is to be understood as contemplating plurality as well as singularity, unless the context suggests otherwise.

The following numbered paragraphs also form a part of this disclosure:

1. A drying cylinder for an image forming apparatus, the drying cylinder comprising: a curved wall; and a plurality of gas outlets spaced apart over the curved wall; wherein the drying cylinder is to continuously rotate about its longitudinal axis and provide gas through the plurality of gas outlets perpendicularly onto a print medium with printing fluid deposited thereon to dry the printing fluid.

2. The drying cylinder of paragraph 1, wherein the plurality of gas outlets comprises a plurality of apertures through the curved wall.

3. The drying cylinder of any of paragraphs 1 to 2, comprising: a heater to heat gas; and a pump to blow the heated gas through the plurality of apertures onto the print medium.

4. The drying cylinder of any of paragraphs 1 to 3, wherein the plurality of gas outlets comprises a plurality of diffusers located on the curved wall, the plurality of diffusers to pump gas onto the print medium.

5. The drying cylinder of any of paragraphs 1 to 4, wherein the drying cylinder is to continuously rotate relative to a print medium with printing fluid deposited thereon moved stepwise past the cylinder to provide a continuously non-zero relative velocity between the curved wall and the print medium.

6. The drying cylinder of any of paragraphs 1 to 5, wherein the longitudinal axis of the drying cylinder is oriented perpendicularly to a print direction of the print medium.

7. The drying cylinder of any of paragraphs 1 to 6, wherein the distance between the two opposite edges of the cylinder is at least the width of a printable area of the print medium.

8. A printing system comprising: a feed unit to move a print medium in a print direction; and a drying cylinder comprising a plurality of gas outlets at the curved wall of the drying cylinder; wherein the longitudinal axis of the drying cylinder is oriented perpendicularly to the print direction; and wherein the feed unit is to move the print medium from a printing region in which a printing fluid is deposited onto the print medium, through a drying region in which the drying cylinder is located; the drying cylinder to rotate about its longitudinal axis and provide gas through the plurality of gas outlets perpendicularly onto the print medium with printing fluid deposited thereon to dry the printing fluid.

9. The printing system of paragraph 8, comprising a print medium diverter to guide the print medium along a feed path which follows a curved path concentric with the curvature of the curved wall of a segment of the drying cylinder.

10. The printing system of paragraph 9, wherein the print medium diverter comprises one or more of: a vacuum unit to pull the print medium onto a curved support plate which follows a curved path concentric with the curvature of the curved wall of a segment of the drying cylinder; and an edge holder to guide an edge of the print medium along a curved path concentric with the curvature of the curved wall of a segment of the drying cylinder.

11. The printing system of any of paragraphs 8 to 10, comprising a printing unit in the printing region, the printing unit to deposit a latex-based printing fluid onto the print medium.

12. The printing system of any of paragraphs 8 to 11, wherein: the feed unit is to move the print medium stepwise in a print direction to move the print medium through the printing system; and the drying cylinder is to continuously rotate as the print medium is moved, stepwise, through the printing system.

13. The printing system of any of paragraphs 8 to 12, wherein the printing system is a roll-to-roll printer system.

14. A method of printing, comprising: moving a print medium, with latex-based printing fluid deposited thereon, stepwise in a print direction to a drying area; and while moving the print medium stepwise, providing gas perpendicularly onto the print medium in the drying area through a plurality of gas outlets in the surface of a continuously rotating drying cylinder to cure the latex-based printing fluid.

15. The method of printing of paragraph 14, comprising: heating gas to be supplied through the plurality of gas outlets; and wherein providing the gas comprises providing the heated gas perpendicularly onto the print medium to cure the latex-based printing fluid.

1. A drying apparatus for an image forming apparatus, the drying apparatus comprising:
a cylinder that is to continuously rotate about a longitudinal axis, the cylinder having an exterior surface around a perimeter of the cylinder, the exterior surface moving in correspondence with rotation of the cylinder; and
a plurality of gas outlets disposed at the exterior surface of the cylinder and spaced apart around the perimeter of the cylinder, the gas outlets moving as the exterior surface of the cylinder moves due to disposition of the gas outlets at the exterior surface wherein as the cylinder rotates, the cylinder is to provide gas through the gas outlets perpendicularly onto a print medium with printing fluid deposited thereon to dry the printing fluid.

2. The drying apparatus of claim 1, wherein the gas outlets comprise apertures through the exterior surface of the cylinder.

3. (canceled)

4. The drying apparatus of claim 1, wherein the plurality of gas outlets comprises a plurality of diffusers located on the curved wall, the plurality of diffusers to pump gas onto the print medium.

5. The drying apparatus of claim 1, wherein the cylinder is to continuously rotate relative to the print medium with the printing fluid deposited thereon moved stepwise past the cylinder to provide a continuously non-zero relative velocity between the exterior surface of the cylinder and the print medium.

6. The drying apparatus of claim 1, wherein the longitudinal axis of the cylinder is oriented perpendicularly to a print direction of the print medium.

7. The drying apparatus of claim 1, wherein the distance between two opposite edges of the cylinder is at least the width of a printable area of the print medium.

8. A printing system comprising:
a feed unit to move a print medium in a print direction; and
a cylinder comprising an exterior surface around a perimeter of the cylinder and a plurality of gas outlets disposed at the exterior surface and spaced apart around the perimeter of the cylinder, the cylinder to continuously rotate about a longitudinal axis that is oriented perpendicularly to the print direction, the exterior surface moving in correspondence with continuous rotation of the cylinder, the gas outlets moving as the exterior surface moves due to disposition of the gas outlets at the exterior surface,
wherein the feed unit is to move the print medium from a printing region in which a printing fluid is deposited onto the print medium, through a drying region in which the drying cylinder is located,
and wherein as the cylinder rotates, the cylinder is to provide gas through the gas outlets perpendicularly onto the print medium with the printing fluid deposited thereon to dry the printing fluid.

9. The printing system of claim 8, further comprising a print medium diverter to guide the print medium along a feed path which follows a curved path concentric with the curvature of a segment of the exterior surface of the cylinder.

10. The printing system of claim 9, wherein the print medium diverter comprises either or both of:
a vacuum unit to pull the print medium onto a curved support plate which follows the curved path concentric with the curvature of the segment of the exterior surface of the cylinder; and
an edge holder to guide an edge of the print medium along the curved path concentric with the curvature of the segment of the exterior surface of the cylinder.

11. The printing system of claim 8, further comprising a printing unit in the printing region to deposit a latex-based printing fluid onto the print medium.

12. The printing system of claim 8, wherein:
the feed unit is to move the print medium stepwise in a print direction to move the print medium through the printing system; and
the cylinder is to continuously rotate as the print medium is moved, stepwise, through the printing system.

13. The printing system of claim 8, wherein the printing system is a roll-to-roll printer system.

14. A method of printing, comprising:
moving a print medium, with latex-based printing fluid deposited thereon, stepwise in a print direction to a drying area; and
while moving the print medium stepwise, providing gas perpendicularly onto the print medium in the drying area through a plurality of gas outlets in the surface of a continuously rotating drying cylinder to cure the latex-based printing fluid.

15. The method of printing of claim 14, comprising:
heating gas to be supplied through the plurality of gas outlets; and
wherein providing the gas comprises providing the heated gas perpendicularly onto the print medium to cure the latex-based printing fluid.
